(19) United States
(12) Patent Application Publication
(10) Pub. No.: US 2004/0110061 A1
(43) Pub. Date: Jun. 10, 2004

(54) Rechargeable, galvanic element with at least one lithium-intercalating electrode

(75) Inventors: Peter Haug, Ellwangen (DE); Peter Birke, Ellwangen (DE); Dejan Ilic, Ellwangen (DE); Rainer Hald, Ellwangen (DE); Thomas Woehrle, Ellwangen (DE)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: VARTA Microbattery GmbH, a corporation of Germany, Hannover (DE)

(21) Appl. No.: 10/682,181

(22) Filed: Oct. 9, 2003

(30) Foreign Application Priority Data
Oct. 25, 2002 (DE) 10250857.7

(51) Int. Cl. H01M 10/50; H01M 2/08

(52) U.S. Cl. 429/62; 429/185

(57) ABSTRACT

The invention includes a rechargeable galvanic element with at least one lithium-intercalating electrode and a sealed thin flexible casing having two metal or composite metal/plastic sheets joined to each other by an adhesive or sealing layer. Inside the element, a PTC element is connected in series into one of the terminal leads. The PTC element is embedded inside the cell or into the edge of the element in the region of an adhesive or a sealing layer and is provided with a plastic coating resistant to organic electrolytes.

### RELATED APPLICATION

This application claims priority of German Patent Application No. DE 102 50 857.7, filed Oct. 25, 2002.

### FIELD OF THE INVENTION

This invention relates to a rechargeable galvanic element with at least one lithium-intercalating electrode. In particular, this invention relates to a sealed thin flexible casing comprising two metal or composite metal/plastic sheets joined to each other by an adhesive or sealing layer.

### BACKGROUND

On account of their high-energy density and the resultant low weight, rechargeable lithium cells in thin flexible casings, also referred to as softpacks, are increasingly being used in portable high-tech equipment such as PDAs, organizers or mobile phones. Because of their high-energy density and the combustible organic electrolyte, however, special safety precautions are taken in the case of this type of cell to allow any risk to the user from improper handling of the cell to be reduced.

Therefore, rechargeable lithium cells have an external electronic safety circuit which monitors the charging and discharging process and protects the cell against improper handling, such as for example an external short-circuit. In many cases, however, protection of the cell by means of external electronics is not adequate. Therefore, safety tests are increasingly being performed on lithium cells without electronics (e.g., Underwriter Laboratories). In this case, such a “naked” cell must withstand an external short-circuit or overcharging of up to 12 volts just as safely as a cell with external safety electronics.

A further requirement of a “naked” lithium cell in a softpack is that it does not overheat, open or even burn up when there is an external short-circuit. Usually used for this purpose in the cell is a so-called “shutdown” separator which melts, loses its porosity and stops further discharging of the cell when the cell is overheated. However, this mechanism is irreversible and under some circumstances begins too late.

The overcharging in particular is extremely critical in the case of rechargeable lithium cells. For example, in the case of a customary lithium-polymer or wound cell comprising a graphite-containing anode and a lithium-cobalt(LiCoO₂)-containing cathode, the following scenario takes place:

Charging to 4.2 Volts:

About 50% of the lithium is deintercalated from the LiCoO₂ and intercalated into the graphite layers of the anode. The electrodes are dimensioned such that the graphite can take up the entire deintercalated lithium.

Charging in Excess of 4.2 Volts:

Further lithium is deintercalated from the LiCoO₂. Metallic lithium is superficially deposited on the anode since the graphite layers are already filled.

Charging Far in Excess of 4.2 Volts:

Constituents of the electrolyte decompose and lead to strong gassing of the cell. Moreover, further deintercalation of the lithium makes the LiCoO₂ structure become increasingly unstable, until it collapses, with the release of reactive oxygen. This process leads to strong heating of the cell until it finally explosively combusts.

Therefore, in the case of lithium wound cells in a hard case (for example an aluminum can), the protection against overcharging is often ensured by an externally attached PTC element (Positive Temperature Coefficient Device). A prerequisite for this is that the heat produced when there is overcharging in the cell is passed on to the PTC by a hard case with good thermal conduction.

It is known from U.S. Pat. No. 5,876,868 and EP 818838 A2 to arrange a PTC element in the closure cap of lithium round cells, which contains a rupture membrane.

U.S. Pat. No. 3,546,024 discloses installation of a temperature switch in a rechargeable Ni/Cd cell, the temperature switch being provided in a free space inside the electrode coil.

It would accordingly be advantageous to provide a galvanic element with over-charging protection, with scarcely any increase in the overall height and volume of the galvanic element and with reliable avoidance of overheating of the cell and subsequent destruction under all operating conditions.

### SUMMARY OF THE INVENTION

This invention relates to a rechargeable galvanic element including at least one lithium-intercalating electrode and a sealed thin flexible casing including two metal or composite metal/plastic sheets joined to each other by an adhesive or a sealing layer, wherein the element has terminal leads as electrical contacts, and wherein, inside the element, a PTC element is connected in series into one of the terminal leads.

### BRIEF DESCRIPTION OF THE DRAWINGS

The invention is further explained below on the basis of FIGS. 1 to 3 as described below:

FIG. 1 shows a perspective view of the basic schematic construction of a cell according to aspects of the invention with an integrated PCT;

FIG. 2 shows an enhanced side view of an integrated PCT element in accordance with aspects of the invention;

FIG. 3 shows another embodiment of an enhanced side view of an integrated PCT element in accordance with aspects of the invention;

FIG. 4 shows yet another embodiment of an enhanced side view of an integrated PCT element in accordance with aspects of the invention;

FIG. 5 graphically shows the behavior of a cell according to the invention under overcharging; and

FIG. 6 graphically shows the behavior of a comparative cell without the PTC element.

### DETAILED DESCRIPTION

It will be appreciated that the following description is intended to refer to specific embodiments of the invention selected for illustration in the drawings and is not intended to define or limit the invention, other than in the appended claims.

The installation of a PTC element into a lithium-polymer cell in a softpack allows a cell which is safe from overcharging and from an external short-circuit to be produced.

Since the PTC element can be introduced into existing free spaces inside the cell, this additional safety element does not cause any loss of energy density. The PTC element is integrated in one of the terminal leads in an electrically conducting manner, for example, by welding or soldering between the electrodes and the external contacts. In this case, the PTC element lies inside the softpack or in its sealing edge. If aggressive electrolytes are used, the PTC element is provided with a plastic coating resistant to organic electrolytes, for example, by means of polyimide adhesive tapes, polyethylene or polypropylene sealing films, epoxy resin, polyurethane or the like.

The PTC element preferably includes a polymer in which conductive particles are present in a well-distributed manner. It has good conductivity at low temperatures, since the conductive particles are then in electrically conductive contact with one another. As from a temperature which is specific to each PTC, the polymer swells, and the conductive particles lose their contact, so that the resistance of the PTC element abruptly increases sharply. A typical PTC element is, for example, the so-called “polyswitch” (designation for PTC elements of the Raychem Corporation, Menlo Park, Calif., USA, which are described in the data book “Current Protection Data Book for Polyswitch Reseftable Fuses” (February 1997) published by Raychem Corporation).

If such a PTC element is connected in series with one of the terminal leads in a lithium-polymer cell, the electrical performance during charging and discharging of the cell is fully obtained at low temperatures. If, however, the cell is greatly overcharged or externally short-circuited, the heat thereby produced in the softpack leads to the abrupt increase in the electrical resistance, so that the overcharging process is interrupted.

It is of special significance that the PTC element is provided insidethe cell or in the softpack which, if appropriate, contains a multiplicity of electrodes stacked one on top of the other, since only in this way does the released heat activate the PTC element promptly when there is overcharging. By contrast, in hard cases with good heat conduction of round cells, provision of the PTC element outside the cell on the softpack casing does not lead to prompt response of the PTC element and there is, consequently, no reliable overcharging protection. One reason for this is the fundamentally inferior heat-conducting softpack casing and another is the gassing of the cell which occurs when there is overcharging with charging voltages far in excess of 4.2 volts and, additionally, reduces the thermal contact with respect to the PTC element.

If a PTC element according to the invention is used, protection against overcharging is ensured up to 32 volts, and the required safety is likewise achieved when there is an external short-circuit. By contrast with the “shutdown” separators usually used, this process is reversible, so that the cell continues to be fully functional after such an external short-circuit.

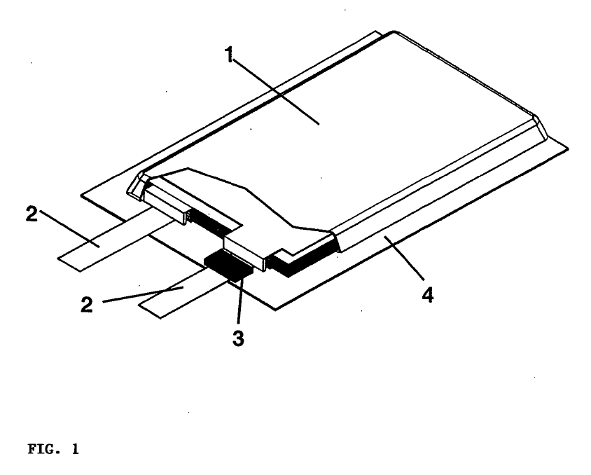

Turning now to the drawings in general and FIG. 1 in particular, a PTC element 3 is electrically integrated into one of the terminal leads 2, consisting of, for example, nickel foil, of the thin galvanic element 1. In particular, it is welded in. It is positioned such that it is arranged in the region of the sealing edge 4 of the cell.

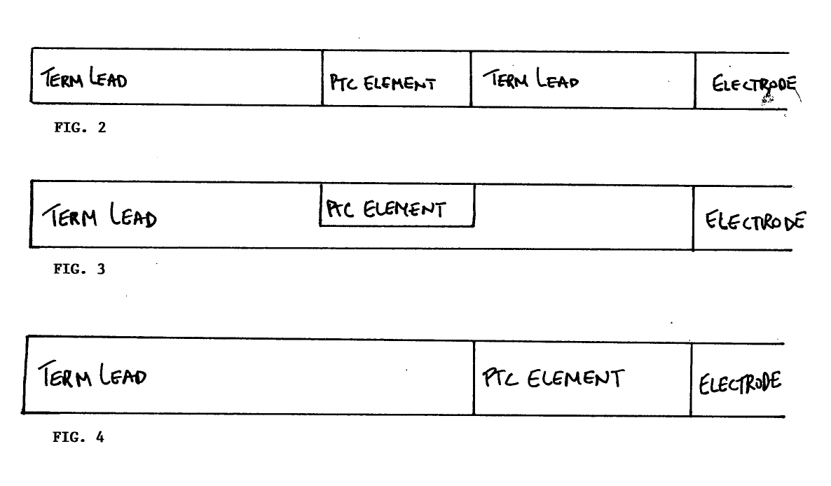

FIGS. 2-4 show representative embodiments of several ways in which the PCT element 3 may be integrated into the terminal leads 2. In the case of FIG. 2, PCT element 3 is located between two portions of terminal lead 2. Thus, terminal lead 2 is separated into two pieces that are welded to each end of PCT element 3.

In FIG. 3, PCT element is embedded into terminal lead 2 and terminal lead 2 is maintained in a single piece. In FIG. 3, terminal lead 2 is in one piece but is welded on one end to PCT element 3, which then connects to the electrode or another component.

Although FIGS. 2-4 represent several preferred ways in which PCT element 3 may be integrated, those of ordinary skill in the art understand that other ways of integrating PCT element 3 are within the scope of the invention.

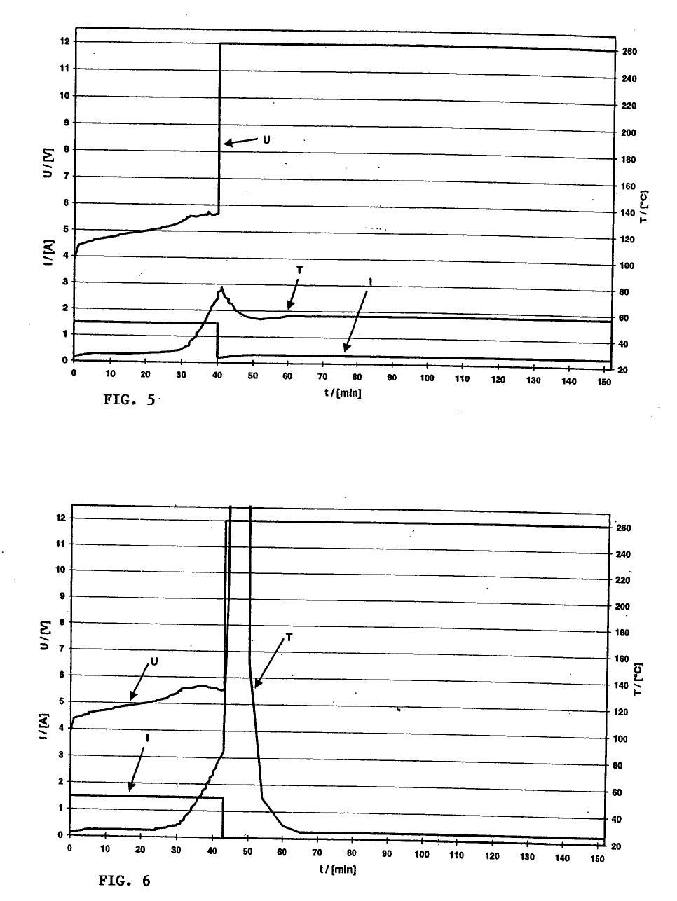

As FIGS. 5 and 6 show, the temperature T of the cells and the voltage U slowly increase up to about 40 minutes. The current I at the same time remains constant at 2C (1.5 A).

In the case of the cell without a PTC element represented in FIG. 6, the temperature T increases exponentially after 43 minutes, and the cell burns up.

The cell with a PTC element (FIG. 5) has after 41 minutes an externally measured temperature maximum of 75° C.; at the same time the voltage U increases abruptly from 5.5 volts to the 12-volt limitation, and the current I drops from 1.5 A to about 200 mA. After about 1 hour, the temperature stabilizes at 55° C. and the current at 300 n-kA.

The following mechanism causes this behaviour:

Up to 40 minutes, the PTC element behaves neutrally or with low resistance. After 41 minutes, the temperature existing at that time in the softpack leads to the PTC element abruptly becoming highly resistive and the current being limited as a result to about 200 mA. The cooling of the PTC causes its conductivity to increase again and, consequently, also causes the current o increase. After about 1 hour, the system has stabilized and found its operating point at 55° C. and 300 mA.

1. A rechargeable galvanic element comprising at least one lithium-intercalating electrode and a sealed thin flexible casing comprising two metal or composite metal/plastic sheets joined to each other by an adhesive or a sealing layer, wherein said element has terminal leads as electrical contacts, and wherein, inside said element, a PTC element is connected in series into one of said terminal leads.

2. The rechargeable galvanic element according to claim 1, wherein said element has an outer edge and said PTC element is embedded into said edge adjacent said adhesive or said sealing layer.

3. The rechargeable galvanic element according to claim 1, wherein said PTC element further comprises a plastic coating resistant to organic electrolytes.

4. The rechargeable galvanic element according to claim 1, wherein said element comprises a multiplicity of electrodes stacked one on top of the other.

5. The rechargeable galvanic element according to claim 1, wherein said PTC element is connected by welding.

6. A rechargeable galvanic element comprising:
at least one lithium-intercalating electrode;
a sealed thin flexible casing comprising metal or composite metal/plastic sheets joined by an adhesive or a sealing layer;
terminal leads extending from the casing as electrical contacts; and
a PTC element connected in series between portions of one of said terminal leads.

7. The rechargeable galvanic element according to claim 6, wherein said element has an outer edge portion and said PTC element is embedded into said edge portion adjacent said adhesive or said sealing layer.

8. The rechargeable galvanic element according to claim 6, wherein said PTC element further comprises a plastic coating resistant to organic electrolytes.

9. The rechargeable galvanic element according to claim 6, wherein said element comprises a multiplicity of electrodes stacked one on top of the other.

10. The rechargeable galvanic element according to claim 6, wherein said PTC element is connected by welding.

11. A rechargeable galvanic element comprising:
at least one lithium-intercalating electrode;
a sealed thin flexible casing comprising metal or composite metal/plastic sheets joined by an adhesive or a sealing layer;
terminal leads extending from the casing as electrical contacts; and
a PTC element integrated into one of said terminal leads.

12. The rechargeable galvanic element according to claim 11, wherein said element has an outer edge portion and said PTC element is embedded into said edge portion adjacent said adhesive or said sealing layer.

13. The rechargeable galvanic element according to claim 11, wherein said PTC element further comprises a plastic coating resistant to organic electrolytes.

14. The rechargeable galvanic element according to claim 11, wherein said element comprises a multiplicity of electrodes stacked one on top of the other.

15. The rechargeable galvanic element according to claim 11, wherein said PTC element is connected by welding.
